(19) United States
(12) Patent Application Publication
(10) Pub. No.: US 2023/0384444 A1
(43) Pub. Date: Nov. 30, 2023

(54) AUTONOMOUS MOVEMENT DEVICE AND AUTONOMOUS MOVEMENT SYSTEM

(71) Applicant: ROHM CO., LTD., Kyoto (JP)

(72) Inventors: Hiroshi YAGUMA, Kyoto (JP); Masahiro YASUDA, Kyoto (JP)

(73) Assignee: ROHM CO., LTD., Kyoto (JP)

(21) Appl. No.: 18/447,961

(22) Filed: Aug. 10, 2023

Related U.S. Application Data
(63) Continuation of application No. PCT/JP2022/006677, filed on Feb. 18, 2022.

(30) Foreign Application Priority Data
Feb. 26, 2021 (JP) 2021-030274

(51) Int. Cl. G01S 13/931; G05D 1/02

(52) U.S. Cl. CPC G01S 13/931; G05D 1/0276

(57) ABSTRACT

The autonomous movement device includes: an reception unit that is an antenna unit configured to receive output information; an angle estimation unit configured to estimate an arrival direction of the output information; a reception strength determination unit configured to determine a reception strength of the output information in the estimated arrival direction; an operation control unit configured generate movement direction information including a movement direction for moving an autonomous movement device, according to the estimated arrival direction and a magnitude of or a change in the reception strength; and a drive unit configured to generate drive information corresponding to the movement direction information.

### CROSS REFERENCE TO RELATED APPLICATIONS AND INCORPORATION BY REFERENCE

This is a continuation application (CA) of PCT Application No. PCT/JP2022/006677, filed on Feb. 18, 2022, which claims priority to Japan Patent Application No. P2021-030274 filed on Feb. 26, 2021 and is based upon and claims the benefit of priority from prior Japanese Patent Application No. P2021-030274 filed on Feb. 26, 2021 and PCT Application No. PCT/JP2022/006677, filed on Feb. 18, 2022; the entire contents of each of which are incorporated herein by reference.

### TECHNICAL FIELD

The present invention relates to an autonomous movement device that autonomously reaches a target object based on output information outputted from the target object, and to an autonomous movement system.

### BACKGROUND

An autonomous traveling vehicle employing SLAM (simultaneous localization and mapping) has been conventionally known. For example, the autonomous traveling vehicle estimates the location of itself by using both of an external sensor such as a camera and a laser sensor and an internal sensor such as an encoder and a gyroscope, and automatically generates a traveling route. Accordingly, the autonomous traveling vehicle can automatically avoid an obstacle without being restricted to fixed routes. Such autonomous traveling vehicles require no infrastructures such as embedding of electric wires in a floor or marking on a floor. The SLAM that uses a camera is referred to as visual SLAM, and the SLAM that uses a laser sensor is referred to as LiDAR SLAM in some cases.

### BRIEF DESCRIPTION OF DRAWINGS

FIG. 1 is a schematic diagram for explaining an outline of an operation of an autonomous movement system including an autonomous movement device according to multiple embodiments.

FIG. 2 is a block diagram illustrating an example of a configuration of the autonomous movement device according to the multiple embodiments.

FIG. 3 is a flowchart illustrating an example of the operation of the autonomous movement system using the autonomous movement device illustrated in FIG. 2.

FIG. 4 is a flowchart illustrating an example of details of step S500 in the flowchart illustrated in FIG. 3.

FIG. 5 is a flowchart illustrating another example of the details of step S500 in the flowchart illustrated in FIG. 3.

FIG. 6 is a flowchart illustrating yet another example of the details of step S500 in the flowchart illustrated in FIG. 3.

### DETAILED DESCRIPTION

Examples of an autonomous movement device and an autonomous movement system according to the present embodiments are described below in detail with reference to the drawings. Note that the embodiments described below describe comprehensive or specific examples. Numerical values, shapes, materials, components, installation positions and connection modes of the components, steps, the order of the steps, and the like described in the following embodiments are examples, and are not intended to limit the present disclosure. Moreover, components that are not described in the independent claims describing the most-generic concept among the components in the following embodiments are described as optional components. Furthermore, dimension ratios in the drawings are exaggerated for convenience of description, and are different from the actual ratios in some cases.

Moreover, the following embodiments and modified examples of thereof sometimes include the same components. The same components are denoted by the same reference numerals, and overlapping description is omitted.

### (Outline of Autonomous Movement Device and Autonomous Movement System)

The autonomous movement device according to the embodiments has a configuration that autonomously reaches a target object in, for example, an internal space of a structure such a factory. Moreover, the autonomous movement device may be configured such that a flight vehicle such a so-called drone autonomously reaches the target object, by using, for example, a propeller or the like that allows movement in the air as a movement mechanism. Furthermore, the autonomous movement device can be used in vehicles such as a passenger vehicle and a bus, moving bodies such as an aircraft, a spaceship, a ship, and a submersible, and be used in internal spaces of buildings such as a house and an office and structures such as a factory or in external spaces in some cases. The autonomous movement device is characterized in that the autonomous movement device reaches the target object while avoiding an obstacle by using information outputted by the target object, without using a radar or an imaging device such as a camera. The information outputted by the target object is not limited to particular information, and includes, for example, a radio wave or a high-frequency electromagnetic wave. The autonomous movement device receives a beacon or the like with multiple antennas, estimates a direction of the target object emitting the beacon or the like by using an arrival direction estimation technique, and can move in the estimated direction. When there is an obstacle outside a line of sight between the target object and the autonomous movement device, there is a case where the autonomous movement device moves in a direction of the beacon reflected on the obstacle. However, there is a case where the autonomous movement device receives the beacon directly received from the target object in middle of the movement. In this case, the autonomous movement device can change a movement direction to the direction of the target object in middle of the movement toward the obstacle, and can resultantly move toward the target object while avoiding the obstacle. Moreover, when an obstacle is present on the line of sight between the target object and the autonomous movement device, a reception strength of the beacon oscillates as the autonomous movement device comes closer to the obstacle. Accordingly, the autonomous movement device can detect presence of the obstacle. As described above, there is a case where causing the autonomous movement device to keep moving in a direction in which the reception strength of the beacon is high while estimating an arrival direction of the beacon allows the autonomous movement device to reach the target object while avoiding an obstacle.

As described above, an imaging device such as a CCD camera or a radar system for route searching employed in the conventional technique does not have be mounted in the autonomous movement device of the present disclosure. Specifically, there is a case where the autonomous movement device of the present disclosure can reach the target object configured to output information by including multiple antennas as well as a control unit and a drive unit that allow the autonomous movement device to head in the arrival direction of the information while measuring the strength of the information. Specifically, there is a case where the autonomous movement device can autonomously reach an object being a target while employing a simple configuration to reduce cost.

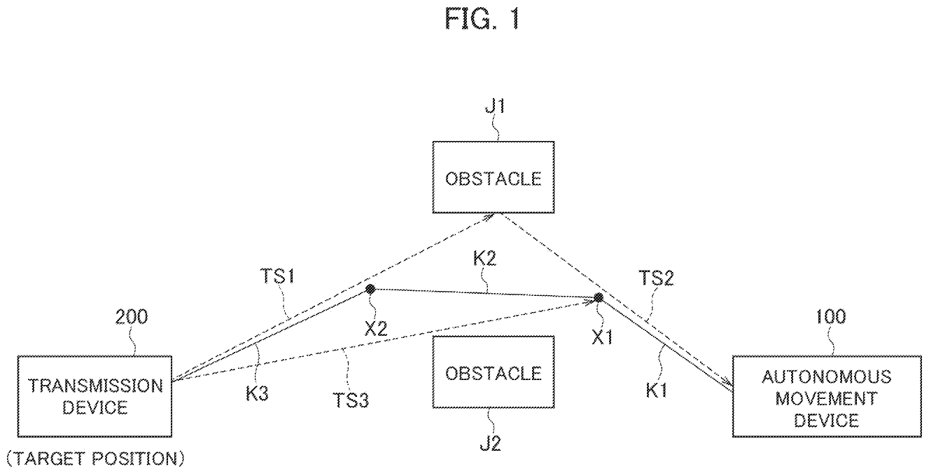

Next, operation principles of an autonomous movement device 100 according to multiple embodiments and an autonomous movement system 1000 including the autonomous movement device 100 are schematically described with reference to FIG. 1. First, the autonomous movement device 100 receives a radio wave of a beacon transmitted from a transmission device 200 arranged at a target position. Since a line of sight of the radio wave of the beacon between the autonomous movement device 100 and the transmission device 200 is blocked, the autonomous movement device 100 receives the beacon via a route K3, a route K2, and then a route K1. Note that there is a possibility that the autonomous movement device 100 receives the beacon also from a line-of-sight direction, depending on the size of an obstacle J2 and the frequency of the beacon. However, the strength of the beacon received via the route K1 is assumed to be the highest. The autonomous movement device 100 estimates a direction of a radio wave with the highest strength with multiple antennas mounted in the autonomous movement device 100, and moves in the estimated radio wave direction.

As the autonomous movement device 100 moving toward an obstacle J1 on the route K1 comes closer to the obstacle J1, the reception strength of the beacon increases. The autonomous movement device 100 thus keeps moving toward the obstacle J1 on the route K1. However, when the autonomous movement device 100 reaches a position x1, the transmission device 200 appears ahead of the line of sight of the autonomous movement device 100, and the autonomous movement device 100 can thus directly receive a beacon TS3. Accordingly, since the reception strength of the beacon TS3 is higher than that of a beacon TS2 at the position x1, the autonomous movement device 100 attempts to change the movement direction to an arrival direction of the beacon TS3. The autonomous movement device 100 can move along a line in the arrival direction of the beacon TS3, but in this case there is a possibility of the autonomous movement device 100 colliding with the obstacle J2. Accordingly, the autonomous movement device 100 recognizes presence of the obstacle J2 from the fact that the autonomous movement device 100 was unable to receive the beacon TS3 up to the position x1 on the route K1 and from the arrival direction estimated by receiving the beacon TS3 with a high strength at the position x1, and moves in a direction of the route K2. The autonomous movement device 100 moving in the direction of the route K2 can recognize presence of the obstacle J1 from the fact that the arrival direction of the beacon outputted from the transmission device 200 is gradually spreading and from the change in the movement direction at the position x1, and estimate the route K3. Then, the autonomous movement device 100 can change the travel direction toward the transmission device 200 at a position x2, and reach the transmission device 200.

Moreover, according to the aforementioned method, the autonomous movement device 100 can reach the target object while avoiding an obstacle in a three-dimensional space. Accordingly, the autonomous movement device 100 can be used in space moving bodies such as a drone, a helicopter, and an aircraft, moving bodies such as a spaceship and a submersible, transport moving bodies in internal spaces or external spaces of buildings such as a house and an office and structures such as a factory, and the like in some cases.

Furthermore, some of functions of the autonomous movement device 100 other than a movement mechanism and an antenna mechanism may be embedded in a ground moving body such as a vehicle, a space moving body, or a transport moving body. Moreover, the functions of the autonomous movement device 100 other than the movement mechanism and the antenna mechanism may be configured to be separate from the various types of moving bodies described above. Furthermore, the autonomous movement system 1000 includes the autonomous movement device 100 and the transmission device 200 described above. The configuration may be such that an imaging device unrelated to a movement control mechanism is attached to the autonomous movement device 100 and movement information of the autonomous movement device 100 is transmitted to a not-illustrated electronic device used by a user to allow the user to monitor a movement status from the electronic device. The electronic device may be a computer arranged on a cloud, a user-used electronic device held by the user such as a mobile phone, a PHS phone, a smartphone, or a mobile information terminal.

### (Details of Autonomous Movement Device)

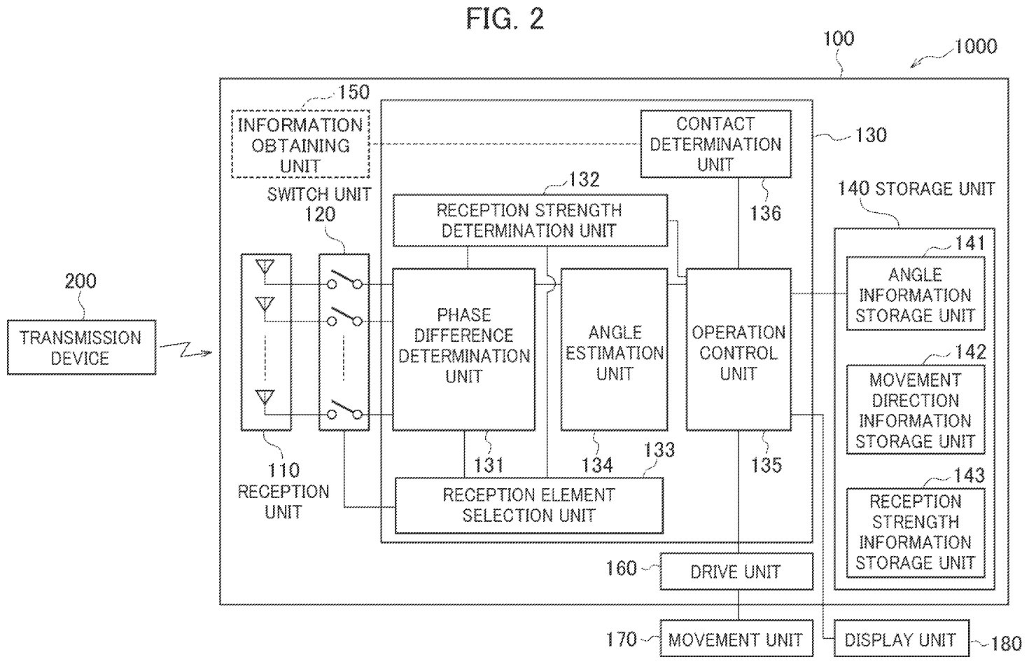

A detailed configuration of the autonomous movement device 100 according to the multiple embodiments is described with reference to FIG. 2. The autonomous movement device 100 includes a reception unit 110 of the multiple antennas and the like, a switch unit 120 configured to select reception elements in the reception unit 110, a control unit 130, a storage unit 140, and a drive unit 160. Note that there may be a case where the autonomous movement device 100 includes an information obtaining unit 150, a movement unit 170, and a display unit 180 as described later. Moreover, the autonomous movement device 100 basically moves by driving the movement unit 170 such as a wheel, a belt, a caterpillar track, or a propeller based on drive information outputted from the drive unit 160 illustrated in FIG. 2. Furthermore, the autonomous movement device 100 may include multiple information obtaining units 150. The information obtaining unit 150 basically does not have to be used for route searching. Note that multiple reception elements are basically provided in the reception unit 110.

The reception unit 110 is configured to be capable of receiving any piece of output information outputted from a not-illustrated information output device. When the output information outputted from the information output device is a radio wave or a high-frequency electromagnetic wave, the reception unit 110 may be an antenna. For example, the reception unit 110 may be an array antenna formed of multiple antenna elements. When the reception unit 110 is the array antenna, arrangement of the antenna elements forming the array antenna may be any arrangement. For example, the antenna elements may be arranged in a row extending in the travel direction of the autonomous movement device 100 or in a direction intersecting, for example, orthogonal to the travel direction. Moreover, the antenna elements may be arranged to form a rectangular shape or an annular shape on a plane not intersecting the travel direction of the autonomous movement device 100 or on a plane intersecting the travel direction. Moreover, the antenna elements may be arranged in a curved shape. Furthermore, the number of array antennas does not have to be one. It is possible to arrange multiple array antennas to improve estimation accuracy of the arrival direction of the radio wave or the like. Moreover, the reception unit 110 may be formed of multiple antennas that have directivities in different directions. Arrangement of the multiple antennas in this case may also be similar to the arrangement of the antenna elements in the array antenna. Moreover, a configuration may be such that partition plates made of a metal or the like are provided in at least one non-directional antenna to enable detection of the strength of the radio wave or the high-frequency electromagnetic wave in directions surrounded by the partition plates.

The switch unit 120 is a switch configured to select any of the reception elements of the reception unit 110 and output information of the radio wave or the like received by the reception element. Accordingly, the configuration may be such that there are as many switches of the switch unit 120 as the reception elements included in the reception unit 110, and one switch corresponds to one reception element. For example, when the reception unit 110 is the array antenna, multiple antenna elements are selected to output information on the strengths, phases, and the like of the radio waves received by the multiple antenna elements to a phase difference determination unit 131 and a reception strength determination unit 132 to be described later. Moreover, the switch unit 120 is preferably a semiconductor switch, but is not limited thereto. A switch with any configuration that can open and close an electric connection can be employed.

The control unit 130 can be implemented by using a microcomputer including a CPU (central processing unit) and the like. A computer program (autonomous movement program) that causes the microcomputer to function as the control unit 130 is installed and executed in the microcomputer. The microcomputer thereby functions as multiple information processors included in the control unit 130. Note that, in the present description, an example in which the control unit 130 is implemented by software is described. However, as a matter of course, it is also possible to prepare dedicated hardware for execution of information processes and form the control unit 130. The dedicated hardware includes devices such as an application specific integrated circuit (ASIC) and a conventional circuit part arranged to execute the functions described in the embodiments. Moreover, the multiple information processors included in the control unit 130 may be formed of individual pieces of hardware. Furthermore, the control unit 130 may be used also as an electronic control device used to control the moving body being the target of the autonomous movement.

For example, when the autonomous movement device 100 is provided in the moving body, the movement control function of the autonomous movement device 100 may be included in functions of the electronic control device that controls configurations unrelated to the movement of the moving body. In this case, there may be employed a mode in which the autonomous movement program that implements the autonomous movement function of the autonomous movement device 100 is added to an electronic control program of the electronic control device. Moreover, there may be employed a mode in which hardware that implements the autonomous movement function of the autonomous movement device 100 is added to hardware of the electronic control device. Furthermore, the configuration may such that at least part of the autonomous movement program of the autonomous movement device 100 is included in at least part of the electronic control program of the electronic control device. Moreover, the configuration may be such that at least part of the hardware of the autonomous movement device 100 is included in at least part of the hardware of the electronic control device. Furthermore, as described above, the autonomous movement function of the autonomous movement device 100 may be included in functions of an electronic control device having a certain function of movement in the internal spaces of buildings such as a house and an office and structures such as a factory or in the external spaces in some cases.

The control unit 130 includes the phase difference determination unit 131, the reception strength determination unit 132, a reception element selection unit 133, an angle estimation unit 134, an operation control unit 135, and a contact determination unit 136 as the multiple information processors.

The phase difference determination unit 131 analyzes reception signals from multiple reception elements of the reception unit 110 selected by the reception element selection unit 133, and determines a phase difference between the reception signals, from a difference between arrival times of the reception signals. The determined phase difference is outputted to the angle estimation unit 134. Moreover, the phase difference determination unit 131 can determine multiple phase differences between multiple reception signals when the autonomous movement device 100 is in a stopped state or a moving state.

The reception strength determination unit 132 determines reception strengths from the multiple reception elements of the reception unit 110 selected by the reception element selection unit 133. The determined reception strengths are outputted to the angle estimation unit 134. Moreover, the estimated reception strengths may be outputted to the reception element selection unit 133. Note that the reception strengths may be expressed in any unit relating to reception strength, and may be expressed as relative information. The reception strengths can be outputted to the angle estimation unit 134 and the reception element selection unit 133 as reception strength information in any format.

The reception element selection unit 133 selects elements for receiving the radio wave or the like, from the multiple reception elements included in the reception unit 110. The number of selected reception elements is preferably one or more. In order to determine the phase difference in the phase difference determination unit 131, the reception element selection unit 133 selects multiple reception elements. Moreover, the configuration may be such that the reception elements are selected in turn, one or more reception elements determined to have a high reception strength is selected in the reception strength determination unit 132, and the arrival direction of the radio wave or the like is estimated in the angle estimation unit 134 via the phase difference determination unit 131.

The angle estimation unit 134 may employ any arrival direction estimation method such as an estimation method as follows. Complex reception responses for an arriving wave are obtained in advance, by using several sets of two antenna elements, from phase differences of the antenna elements, and an evaluation function is introduced to set an angle at which an evaluation function value is the largest as the arrival direction. Moreover, the angle estimation unit 134 can estimate the arrival direction from the phase differences of the multiple antenna elements. For example, the angle estimation unit 134 may employ a MUSIC (multiple signal classification) or a Root-Music method using eigenvalues and eigenvectors of a correlation matrix. Moreover, the angle estimation unit 134 may employ an ESPRIT (estimation of signal parameters via rotational invariance techniques) method. The angle estimated as described above is stored in an angle information storage unit 141 of the storage unit 140 as information of an angle with respect a certain reference axis. Moreover, there is a case where the estimated angle information is stored in the angle information storage unit 141 in association with the reception strength determined in the reception strength determination unit 132. Furthermore, there is a case where the estimated angle information is stored in the angle information storage unit 141 in association with the determined reception strength and time point information. The reception unit 110 can receive the time point information from the outside of the autonomous movement device 100, or the autonomous movement device 100 can perform time measurement by using a not-illustrated timer.

Moreover, there is a case where multiple angles are estimated in the angle estimation unit 134. When there are multiple estimated angles, the angle estimation unit 134 may receive the reception strength at each angle from the reception strength determination unit 132, and store the reception strength and the corresponding angle in the angle information storage unit 141 in association with each other. For example, when an obstacle is present, there is a case where a radio wave reflected on the obstacle and a radio wave propagating on the line of sight are received by the autonomous movement device 100 at different angles. Moreover, there is a case where the radio wave reflected on the obstacle is further reflected by another obstacle, and is received by the autonomous movement device 100 at yet another angle. As described above, there is a case where the reflected wave from the obstacle is reflected multiple times and reaches the autonomous movement device 100. The autonomous movement device 100 basically moves in a direction in which the reception strength is high. However, there is a possibility of occurrence of a case where the autonomous movement device 100 cannot move in the direction in which the reception strength is high due to an obstacle or the case where the direction in which the reception strength is high is a wrong route. Since there may occur a case where the autonomous movement device 100 has to move in a direction of a different reflected wave, when multiple angles are estimated, the autonomous movement device 100 may store information on the multiple angles in the angle information storage unit 141 in association with the reception strengths.

The operation control unit 135 basically causes the autonomous movement device 100 to move in the direction estimated by the angle estimation unit 134. However, when the reception strength determined by the reception strength determination unit 132 in the estimated direction periodically oscillates, there is a case where the operation control unit 135 determines that an obstacle is present in the estimated direction, after causing the autonomous movement device 100 to move a certain predetermined distance or for a certain predetermined time. For example, there is a case where the autonomous movement device 100 comes close to the back side of an obstacle present between the autonomous movement device 100 and the target object. In such a case, since the autonomous movement device 100 sometimes receives a diffracted wave, there is a case where the reception strength of the diffracted wave periodically oscillates.

Moreover, the operation control unit 135 can calculate a past movement history of the autonomous movement device 100 from the movement information stored in a movement direction information storage unit 142, and generate map information. For example, when the operation control unit 135 can determine that the autonomous movement device 100 has moved in the past in the estimated direction from the currently present location, the operation control unit 135 may cause the autonomous movement device 100 to move in a direction with the next highest reception strength estimated by the angle estimation unit 134. Moreover, when an arrival direction of a radio wave with a higher reception strength is estimated during the movement, there is a case where the operation control unit 135 changes the movement direction of the autonomous movement device 100 based on determination of the contact determination unit 136 to be described later. The operation control unit 135 may store the movement direction and a movement time or a movement distance in this movement direction in the movement direction information storage unit 142 in association with each other. As described above, the operation control unit 135 can calculate the past movement history from the aforementioned information stored in the movement direction information storage unit 142 to generate the map information, and avoid following a failed route. Moreover, when the time point information is associated with the movement direction information, there is a case where the operation control unit 135 selects the past movement route if a predetermined time or more has elapsed. For example, when an obstacle is a moving body, if the obstacle has moved away from the past route or from the vicinity of the past route, there may be a case where a newly-estimated radio wave arrival direction overlaps the past route due to the movement of the moving body.

Moreover, in cases such as a case where the radio wave strength is very low and a case where the angle estimation unit 134 cannot estimate the radio wave arrival direction, the operation control unit 135 causes the autonomous movement device 100 to move while maintaining the current movement direction in some cases. For example, when an emitted radio wave and a reflected radio wave interfere with each other and a null point is generated, there is a case where the estimation of the radio wave arrival direction becomes possible again by causing the autonomous movement device 100 to move to another point.

Furthermore, when the operation control unit 135 receives contact prediction information or contact information from the contact determination unit 136, the operation control unit 135 may change the movement direction such that the obstacle is avoided. In this case, the changed direction is maintained temporarily or for a predetermined time in some cases. Note that there is a case where the changed direction is not the estimated direction of the radio wave with the highest reception strength.

Moreover, the operation control unit 135 may execute machine learning or deep learning by using information such as the movement history information, the angle information, and the radio wave estimated direction information, and store machine learning result information or deep learning result information in the storage unit 140. Moreover, the machine learning result information or the deep learning result information may be stored in the storage unit 140 in association with information such as the movement direction information, the angle information, and the radio wave estimated direction information.

There is a case where the contact determination unit 136 determines whether there is a possibility of the autonomous movement device 100 coming into contact with an obstacle, based on obtained information optionally obtained by the information obtaining unit 150. Although FIG. 2 illustrates a case where the information obtaining unit 150 is present, the contact determination unit 136 may determine whether there is the possibility of the autonomous movement device 100 coming into contact with an obstacle, not based on the obtained information of the information obtaining unit 150. For example, when the reception strength in the movement direction periodically oscillates, the contact determination unit 136 may determine that an obstacle is present in the movement direction. However, the contact determination unit 136 may determine that an obstacle is present in the movement direction when the reception strength in the movement direction periodically oscillates after movement of a predetermined distance or a predetermined time, in view of an effect of fading or the like. Moreover, when an arrival direction of a radio wave with a higher reception strength than the reception strength in the movement direction is estimated, the contact determination unit 136 may determine that an obstacle is present between the movement direction and the arrival direction of the radio wave with the higher reception strength, on the past movement direction side. The contact determination unit 136 may also determine that, when the movement direction is immediately changed to the arrival direction of the radio wave with the higher reception strength, there is a possibility of the autonomous movement device 100 coming into contact with an obstacle in the width direction. Furthermore, when there is no change in the reception strength, the contact determination unit 136 may determine that the autonomous movement device 100 has come into contact with an obstacle and is unable to perform a direction change such as forward travel or backward travel. Moreover, when it is estimated that the radio wave arrival direction changes as if to rotate, the contact determination unit 136 may determine that the autonomous movement device 100 has come into contact with an obstacle and is rotating. The contact determination unit 136 may notify the operation control unit 135 of such determination information.

When the information obtaining unit 150 is present as an option, the contact determination unit 136 may determine whether there is the possibility of the autonomous movement device 100 coming into contact with an obstacle, based on the obtained information. For example, the information obtaining unit 150 may be a sensor capable of detecting an obstacle around the autonomous movement device 100 such as an infrared sensor, an ultrasonic sensor, and the like. When the information obtaining unit 150 detects an obstacle, the information obtaining unit 150 transmits information on the detected obstacle to the contact determination unit 136. When the contact determination unit 136 predicts that the autonomous movement device 100 is to come into contact with an obstacle based on the obtained information on the obstacle and the movement direction and size of the autonomous movement device 100, the contact determination unit 136 transmits the contact prediction information to the operation control unit 135. Moreover, when the contact determination unit 136 determines that the autonomous movement device 100 is in contact with an obstacle, the contact determination unit 136 transmits the contact information to the operation control unit 135.

Moreover, the information obtaining unit 150 may be an imaging element such as a CCD camera. When the information obtaining unit 150 is the imaging element, the information obtaining unit 150 is configured such that an imager of the imaging element faces the movement direction of the autonomous movement device 100. The configuration may be such that the contact determination unit 136 determines whether there is an obstacle in imaging information imaged by the imaging element, and output a determination result to the operation control unit 135. In this configuration, the contact determination unit 136 can analyze obstacle information such as the position, direction, distance, size, and the like of the obstacle, from the imaging information. Accordingly, the operation control unit 135 can select a suitable radio wave arrival direction based on the obstacle information. Moreover, the information obtaining unit 150 may be provided to simply provide the imaging information to the user.

The storage unit 140 is a computer-readable storage unit medium. For example, the storage unit 140 may be a ROM (read only memory) or an EPROM (erasable programmable ROM). Moreover, the storage unit 140 may be an EEPROM (electrically erasable programmable ROM), a RAM (random access memory), a hard disk drive, or the like. The storage unit 140 may be referred to as a register, a cache, a main memory (main storage unit device), or the like. A program (program code), a software module, or the like that can be executed to perform the autonomous movement according to one embodiment of the present disclosure can be saved in the storage unit 140.

Note that the storage unit 140 includes the angle information storage unit 141, the movement direction information storage unit 142, and a reception strength information storage unit 143.

The angle information of the radio wave whose radio wave arrival direction is estimated in the angle estimation unit 134 is stored in the angle information storage unit 141. The angle information is information with respect to a predetermined reference axis in some cases, and this reference axis is based on a physical profile of the autonomous movement device 100 in some cases. For example, the configuration may be such that this profile is expressed with two-dimensional relative coordinates different from a space in which the autonomous movement device 100 is moving, and a line expressed by the relative coordinates is set as the reference axis. The angle information may be stored in association with the reception strength information of the radio wave for which the estimation is performed and the time point information at which the angle information is estimated. In the aforementioned predetermined case, the angle information other than the angle information of the highest reception strength is used in some cases, and this is because there may be a case where the angle information needs to be compared with past angle information. Moreover, the angle information may express an angle changed from an angle determined first, and be stored to facilitate creation of the map information.

The movement direction information that is determined in the operation control unit 135 and that indicates the movement direction in which the autonomous movement device 100 has actually moved may be stored in the movement direction information storage unit 142 in association with the time point information of start of the movement in the movement direction and the time point information of completion of the movement in the movement direction. Moreover, the time point information of start of the movement in the movement direction or the time point information of completion of the movement in the movement direction and time information of the movement in the movement direction may be stored in the movement direction information storage unit 142 in association with the movement direction information. The operation control unit 135 may reproduce a past movement route of the autonomous movement device 100 based on these pieces of information. The operation control unit 135 may select a route so as not to follow the same movement route to reach the target object, by reference to the past movement route. Moreover, the contact determination unit 136 may estimate a position of an obstacle by reference to the past movement route. Furthermore, the control unit 130 may execute machine learning or deep learning, and store the machine learning result information or the deep learning result information in the storage unit 140 including the movement direction information storage unit 142. Furthermore, the machine learning result information or the deep learning result information may be stored in association with information such as the movement direction information, the angle information, and the radio wave estimated direction information.

The reception strength information of the radio waves received by the multiple reception elements that is determined in the reception strength determination unit 132 may be stored in the reception strength information storage unit 143. Moreover, the reception strengths of the radio waves in the estimated radio wave arrival direction of the radio waves received by the multiple reception elements may be stored in the reception strength information storage unit 143. Furthermore, the reception strength information may be stored in the reception strength information storage unit 143 in association with the time point information of the determination of the reception strengths.

The drive unit 160 includes a mechanism configured to drive the movement unit 170 to move the autonomous movement device 100 in the direction determined by the operation control unit 135. For example, when the movement unit 170 is a tire, the drive unit 160 is a mechanism configured to rotate the tire. When the movement unit 170 is a caterpillar track, the drive unit 160 is a mechanism configured to turn the caterpillar track. When the movement unit 170 is a propeller, the drive unit 160 includes a mechanism configured to rotate the propeller. Note that the drive unit 160 is not limited to the aforementioned modes, and may include any drive configuration configured to drive the configuration of the movement unit 170.

The movement unit 170 is a portion forming means for moving the autonomous movement device 100. When the autonomous movement device 100 is a vehicle, the movement unit 170 may be a wheel including a tire, a caterpillar track, or the like. Moreover, when the autonomous movement device 100 is a flight vehicle such as a drone or a helicopter, the movement unit 170 may be a propeller. Note that the movement unit 170 is not limited to the aforementioned modes, and may include any movement mechanism that can move the autonomous movement device 100.

The display unit 180 is an option, is attached to the autonomous movement device 100 or installed in a monitor space located away from the autonomous movement device 100, and can be used to check image information in the movement direction of the autonomous movement device 100. Checking the image information outputted on the display unit 180 as described above enables checking of whether the autonomous movement device 100 is normally moving.

The transmission device 200 may be arranged around the target object or attached to the target object. Moreover, there is a case where the transmission device 200 is the target object. The information outputted by the transmission device 200 needs to be information receivable by the reception unit 110 of the autonomous movement device 100. As described above, examples of the information outputted by the transmission device 200 includes the radio wave and the high-frequency electromagnetic wave. However, the information is not limited to this, and may be an electromagnetic wave of any frequency, an oscillating wave, or the like. Moreover, the frequency of the radio wave the oscillating wave, or the like does not have to be fixed, and may be periodically or randomly changed. Furthermore, the transmission device 200 may be configured to repeatedly sweep frequencies in a predetermined frequency range. Causing the frequency to fluctuate facilitates determination of presence of an obstacle in some cases even when the autonomous movement device 100 includes no information obtaining unit 150. Moreover, the transmission device 200 may be a user-used electronic device held by the user such as a mobile phone, a PHS phone, a smartphone, or a mobile information terminal.

The autonomous movement device 100 according to the embodiments may further include a not-illustrated transmission unit configured to transmit information on reaching of the target object or information on abnormality during the movement, to the outside by wired or wireless means. The transmission unit may wirelessly transmit the reaching information and the abnormality information to an external electronic device by so-called mobile communication. Moreover, the autonomous movement device 100 may perform wireless communication based on at least one of short-range communication standards of wireless LAN and Bluetooth (registered trademark). Alternatively, the transmission unit may perform communication with the outside by being connected via a cable (for example, a USB cable or an optical cable). In such a configuration, other devices can execute the following processes in response to reception of the reaching information or the abnormality information.

A transmission destination of the transmission unit may be, for example, a computer arranged on a cloud or the user-used electronic device held by the user such as a mobile phone, a PHS phone, a smartphone, or a mobile information terminal.

According to the aforementioned configuration, it is possible to autonomously reach an object being a target while employing a simple configuration to reduce cost in a movement device such as an unmanned transport vehicle.

### (Operation Example of Autonomous Movement Device and Autonomous Movement System)

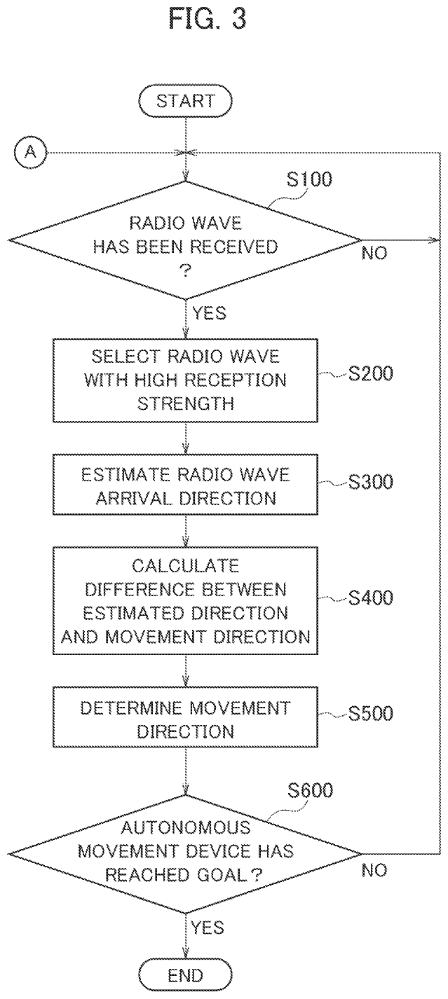

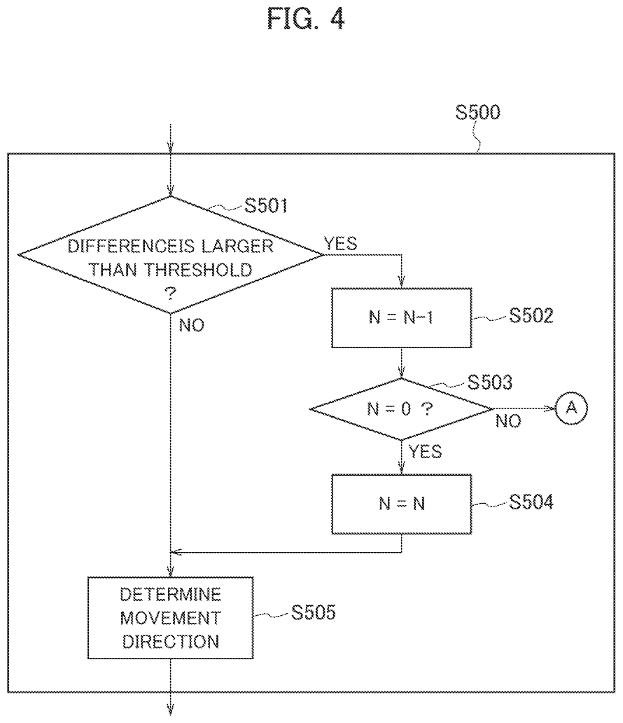

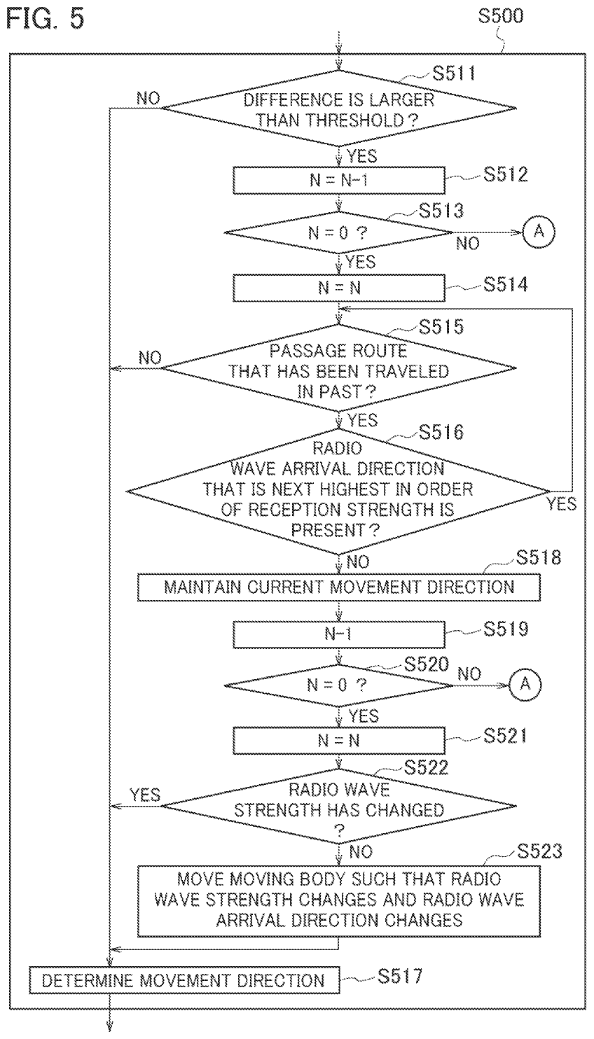

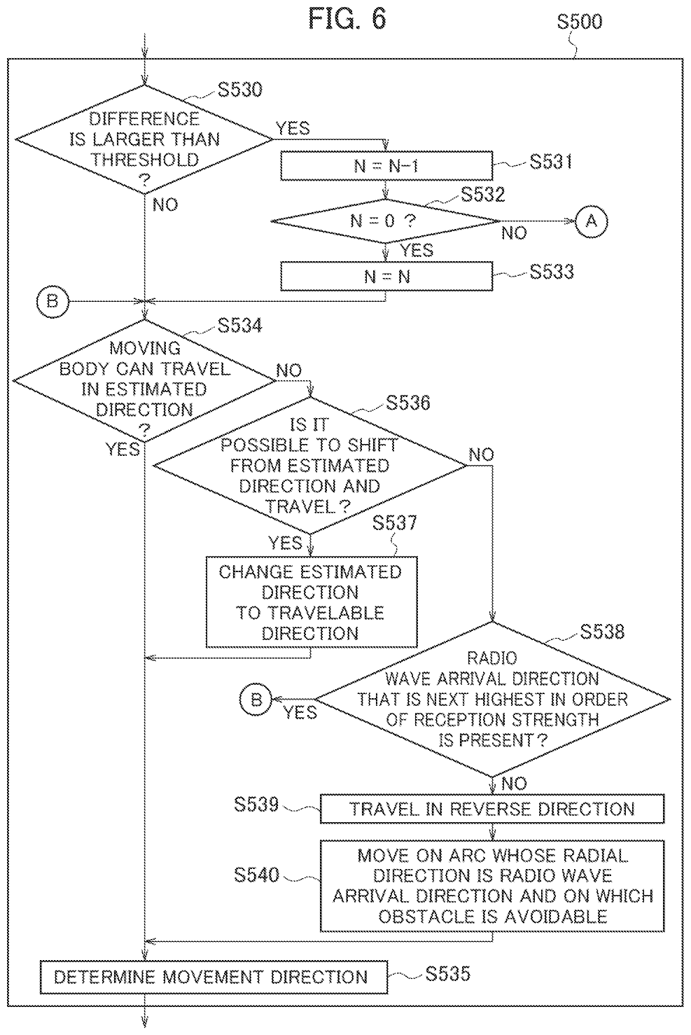

Next, an example of an outline of a basic operation of the autonomous movement device 100 and the autonomous movement system 1000 illustrated in FIG. 2 is described by using a flowchart with reference to FIG. 3. Moreover, an example of details of step S500 in FIG. 3 is described with reference to FIG. 4. Furthermore, another example of the details of step S500 in FIG. 3 is described with reference to FIG. 5. Moreover, yet another example of the details of step S500 in FIG. 3 is described with reference to FIG. 6. Note that the case where there the output information is the radio wave is described below.

In step S100, the reception strength determination unit 132 determines whether the reception elements of the reception unit 110 have received the output information exceeding a predetermined threshold. The predetermined threshold is any value that can be predetermined in the autonomous movement device 100 or the autonomous movement system 1000. Moreover, the configuration may be such that the reception elements for which the reception strength is checked are predetermined or are randomly selected. When the reception elements receive the output information exceeding the predetermined threshold (step S100: YES), the autonomous movement device 100 proceeds to step S200. When the predetermined threshold is not exceeded in the reception elements (step S100: NO), the autonomous movement device 100 repeats step S100.

In step S200, the reception strength determination unit 132 measures and determines the reception strength in each reception element, and controls the reception element selection unit 133 such that the reception elements in which the reception strength of the output information is high are selected. The number of reception elements to be selected may be any number. Next, the autonomous movement device 100 proceeds to step S300.

In step S300, the phase difference determination unit 131 measures and determines a phase difference between received radio waves of the reception elements, and outputs the phase difference to the angle estimation unit 134. The angle estimation unit 134 having received the phase difference estimates the radio wave arrival direction by reference to the distance between the corresponding reception elements and the reception strengths as necessary. The estimated radio wave arrival direction can be indicated by using coordinates of a space in which the reception elements are arranged. The estimated radio wave arrival direction is outputted from the angle estimation unit 134 to the operation control unit 135. Next, the autonomous movement device 100 proceeds to step S400.

In step S400, the operation control unit 135 calculates a difference between the radio wave arrival direction and a direction in which the autonomous movement device 100 is moving or a travel direction at a stop position of the autonomous movement device 100. Next, the autonomous movement device 100 proceeds to step S500.

In step S500, the operation control unit 135 determines the movement direction of the autonomous movement device 100, and controls the drive unit 160 and the movement unit 170 such that the autonomous movement device 100 moves in the determined movement direction. Note that several specific examples of step S500 are described by using FIGS. 4 to 6. Next, the autonomous movement device 100 proceeds to step S600.

In step S600, the operation control unit 135 determines whether the autonomous movement device 100 has reached the target object. The configuration may be such that the radio wave is emitted by the target object, or is emitted from the transmission device 200 arranged around the target object. When the autonomous movement device 100 has reached the target object (step 600: YES), the autonomous movement device 100 terminates the processing. When the autonomous movement device 100 has not reached the target object (step S600: NO), the autonomous movement device 100 returns to step S100.

According to the aforementioned configuration, it is possible to autonomously reach an object being a target while employing a simple configuration to reduce cost in a movement device such as an unmanned transport device or the like.

Next, one example of the details of step S500 in FIG. 3 is described with reference to FIG. 4. FIG. 4 illustrates an operation of suspending determination for a predetermined time to determine whether the estimated radio wave arrival direction is correct in view of an effect caused by interference of radio waves or the like when the difference between the estimated radio wave arrival direction and the movement direction of the autonomous movement device 100 are large.

In step S501, the operation control unit 135 determines whether the difference between the estimated radio wave arrival direction and the movement direction of the autonomous movement device 100 exceeds a predetermined threshold. The predetermined threshold can be determined to be any value in the autonomous movement device 100 or the autonomous movement system 1000. When the difference between the estimated radio wave arrival direction and the movement direction of the autonomous movement device 100 exceeds the predetermined threshold (step S501: YES), the operation control unit 135 proceeds to step S502. When the difference between the estimated radio wave arrival direction and the movement direction of the autonomous movement device 100 is equal to or smaller than the predetermined threshold (step S501: NO), the operation control unit 135 proceeds to step S505.

In step S502, the operation control unit 135 decrements a variable N. The value of the variable N can be determined to be any given value in the autonomous movement device 100 or the autonomous movement system 1000. Next, the autonomous movement device 100 proceeds to step S503.

In step S503, the operation control unit 135 determines whether the variable N has reached zero. When the variable N has reached zero (step S503: YES), the operation control unit 135 proceeds to step S504. When the variable N has not reached zero (step S503: NO), the operation control unit 135 returns to step S100.

In step S504, the operation control unit 135 sets the variable N to the any value determined in the autonomous movement device 100 or the autonomous movement system 1000. Next, the autonomous movement device 100 proceeds to step S505.

In step S505, the operation control unit 135 determines the estimated radio wave arrival direction as the movement direction of the autonomous movement device 100, and generates the movement direction information. Next, the autonomous movement device 100 proceeds to step S600.

According to the aforementioned configuration, when the difference between the estimated radio wave arrival direction and the movement direction of the autonomous movement device 100 are large, it is possible to determine validity of the estimated radio wave arrival direction by not changing the movement direction of the autonomous movement device 100 for a predetermined time in view of the effect caused by interference of radio waves and the like in some cases.

Next, another example of the details of step S500 in FIG. 3 is described with reference to FIG. 5. FIG. 5 illustrates an operation in which the movement direction traveled in the past is avoided to prevent the movement route from forming a loop, in addition to the operation of FIG. 4.

In step S511, the operation control unit 135 determines whether the difference between the estimated radio wave arrival direction and the movement direction of the autonomous movement device 100 exceeds the predetermined threshold. When the difference between the estimated radio wave arrival direction and the movement direction of the autonomous movement device 100 exceeds the predetermined threshold (step S511: YES), the operation control unit 135 proceeds to step S512. When the difference between the estimated radio wave arrival direction and the movement direction of the autonomous movement device 100 is equal to or smaller than the predetermined threshold (step S511: NO), the operation control unit 135 proceeds to step S517.

In step S512, the operation control unit 135 decrements the variable N. The value of the variable N can be determined to be any value in the autonomous movement device 100 or the autonomous movement system 1000. Next, the autonomous movement device 100 proceeds to step S513.

In step S513, the operation control unit 135 determines whether the variable N has reached zero. When the variable N has reached zero (step S513: YES), the operation control unit 135 proceeds to step S514. When the variable N has not reached zero (step S513: NO), the operation control unit 135 returns to step S100.

In step S514, the operation control unit 135 sets the variable N to the any value determined in the autonomous movement device 100 or the autonomous movement system 1000. Next, the autonomous movement device 100 proceeds to step S515.

In step S515, the operation control unit 135 determines whether the estimated radio wave arrival direction matches a past movement route. When the estimated radio wave arrival direction matches the past movement route (step S515: YES), the operation control unit 135 proceeds to step S516. When the estimated radio wave arrival direction does not match the past movement route (step S515: NO), the operation control unit 135 proceeds to step S517.

In step S516, the operation control unit 135 determines whether there is a radio wave arrival direction that is the next highest in the order of reception strength. When there is a radio wave arrival direction that is the next highest in the order of reception strength (step S516: YES), the operation control unit 135 proceeds to step S515. When there is no radio wave arrival direction that is the next highest in the order of reception strength (step S516: NO), the operation control unit 135 proceeds to step S518.

In step S517, the operation control unit 135 determines the estimated radio wave arrival direction as the movement direction of the autonomous movement device 100, and generates the movement direction information. Moreover, when the operation control unit 135 proceeds from step S522 or step S523 to step S517, the current movement direction is maintained. Next, the autonomous movement device 100 proceeds to step S600.

In step S518, the operation control unit 135 discards the estimated radio wave arrival direction, and maintains the current movement direction of the autonomous movement device 100. Next, the autonomous movement device 100 proceeds to step S519.

In step S519, the operation control unit 135 decrements the variable N. The value of the variable N can be determined to be any value in the autonomous movement device 100 or the autonomous movement system 1000. Next, the autonomous movement device 100 proceeds to step S520.

In step S520, the operation control unit 135 determines whether the variable N has reached zero. When the variable N has reached zero (step S520: YES), the operation control unit 135 proceeds to step S521. When the variable N has not reached zero (step S520: NO), the operation control unit 135 returns to step S100.

In step S521, the operation control unit 135 sets the variable N to the any value determined in the autonomous movement device 100 or the autonomous movement system 1000. Next, the autonomous movement device 100 proceeds to step S522.

In step S522, the operation control unit 135 determines whether the reception strength of the received radio wave has changed. This is because, when the reception strength has not changed, it is assumed that the autonomous movement device 100 has come into contact with an obstacle and cannot move. When the reception strength of the received radio wave has changed (step S522: YES), the operation control unit 135 proceeds to step S517. When the reception strength of the received radio wave has not changed (step S522: NO), the operation control unit 135 proceeds to step S523.

In step S523, the operation control unit 135 causes the autonomous movement device 100 to move such that the reception strength of the radio wave changes and the radio wave arrival direction changes by performing rearward travel or the like. It is possible to search for a direction in which the radio wave arrival direction changes by using a combination of reception elements in the reception unit 110. Next, the operation control unit 135 proceeds to step S517.

According to the aforementioned operation, it is possible to execute the operation in which the movement direction traveled in the past is avoided to prevent the movement route from forming a loop, in addition to the operation of FIG. 4. Moreover, it is possible to autonomously change the movement direction and search for a new movement direction when the autonomous movement device 100 cannot travel forward due an obstacle.

Next, yet another example of the details of step S500 in FIG. 3 is described with reference to FIG. 6. FIG. 6 illustrates an operation in which, when an obstacle is present in the movement direction, contact with the obstacle is prevented, in addition to the operation of FIG. 4.

In step S530, the operation control unit 135 determines whether the difference between the estimated radio wave arrival direction and the movement direction of the autonomous movement device 100 exceeds the predetermined threshold. When the difference between the estimated radio wave arrival direction and the movement direction of the autonomous movement device 100 exceeds the predetermined threshold (step S530: YES), the operation control unit 135 proceeds to step S531. When the difference between the estimated radio wave arrival direction and the movement direction of the autonomous movement device 100 is equal to or smaller than the predetermined threshold (step S530: NO), the operation control unit 135 proceeds to step S534.

In step S531, the operation control unit 135 decrements the variable N. The value of the variable N can be determined to be any value in the autonomous movement device 100 or the autonomous movement system 1000. Next, the autonomous movement device 100 proceeds to step S532.

In step S532, the operation control unit 135 determines whether the variable N has reached zero. When the variable N has reached zero (step S532: YES), the operation control unit 135 proceeds to step S533. When the variable N has not reached zero (step S532: NO), the operation control unit 135 returns to step S100.

In step S533, the operation control unit 135 sets the variable N to the any value determined in the autonomous movement device 100 or the autonomous movement system 1000. Next, the autonomous movement device 100 proceeds to step S534.

In step S534, the operation control unit 135 determines whether there is a possibility of the autonomous movement device 100 coming into contact with an obstacle if the autonomous movement device 100 moves in the estimated radio wave arrival direction. As described above, there is a case where the operation control unit 135 can determine whether there is a possibility of contact with an obstacle based on the information received by the reception unit 110 of the autonomous movement device 100. Moreover, there is a case where the operation control unit 135 can perform the determination based on the obtained information obtained by the information obtaining unit 150. When there is no possibility of the autonomous movement device 100 coming into contact with an obstacle (step S534: YES), the operation control unit 135 proceeds to step S535. When there is a possibility of the autonomous movement device 100 coming into contact with an obstacle (step S534: NO), the operation control unit 135 proceeds to step S536.

In step S535, the operation control unit 135 determines the estimated radio wave arrival direction as the movement direction of the autonomous movement device 100, and generates the movement direction information. Moreover, when the operation control unit 135 proceeds from step S537 or S540 to step S535, the movement direction determined in a corresponding one of step S537 or S540 is maintained. Next, the autonomous movement device 100 proceeds to step S600.

In step S536, the operation control unit 135 determines whether there is a movement direction in which the autonomous movement device 100 can travel forward without coming into contact with the obstacle, on the radio wave arrival direction side estimated from a straight line perpendicular to the estimated radio wave arrival direction. When there is a movement direction in which the autonomous movement device 100 can travel forward without coming into contact with the obstacle (step S536: YES), the operation control unit 135 proceeds to step S537. When there is no movement direction in which the autonomous movement device 100 can travel forward without coming into contact with the obstacle (step S536: NO), the operation control unit 135 proceeds to step S538.

In step S537, the operation control unit 135 changes the movement direction of the autonomous movement device 100 to the movement direction in which the autonomous movement device 100 can travel forward without coming into contact with the obstacle, on the radio wave arrival direction side estimated from the straight line perpendicular to the estimated radio wave arrival direction. Next, the operation control unit 135 proceeds to step S535.

In step S538, the operation control unit 135 determines whether there is a radio wave arrival direction that is the next highest in the order of reception strength. When there is a radio wave arrival direction that is the next highest in the order of reception strength (step S538: YES), the operation control unit 135 proceeds to step S534. When there is no radio wave arrival direction that is the next highest in the order of reception strength (step S538: NO), the operation control unit 135 proceeds to step S539.

In step S539, the operation control unit 135 causes the autonomous movement device 100 to travel in a reverse direction. Next, the operation control unit 135 proceeds to step S540.

In step S540, the operation control unit 135 estimates a radio source of the radio wave arrival direction from a rate of attenuation of the radio wave strength in the radio wave arrival direction due to the reverse travel, estimates a radius in the radio wave arrival direction, moves along an arc in which the radius in the radio wave arrival direction is set as an arc, and moves while avoiding the obstacle. Next, the operation control unit 135 proceeds to step S535.

According to the aforementioned operation, when an obstacle is present in the movement direction, contact with the obstacle can be prevented in some cases.

### Modified Example

Since the autonomous movement device 100 can detect multiple radio wave arrival directions, a radio source by a virtual image or a real image is estimated to be present at an intersection of the multiple radio wave arrival directions. Moreover, since the radio source by the virtual image is formed by interference such as reflection and diffraction, a possibility of the radio source estimated to be at the same position is low. In view of the radio source by the virtual image or the real image, if the radio source can be estimated to be the radio source by the virtual image by changing the movement direction, the possibility of discarding the radio source by the virtual image and narrowing down the radio source by the real image increases in some cases. Accordingly, in some cases, it is advantageous that the autonomous movement device 100 changes the movement direction in view of the radio source by the virtual image or the real image.

Specifically, when the reception strength determination unit 132 of the autonomous movement device 100 determines that the output information has a reception strength exceeding the predetermined threshold, in some cases, it is preferable that the autonomous movement device 100 moves a predetermined distance. In this case, it is preferable that the angle estimation unit 134 estimates the arrival direction of the output information during the movement. Moreover, in some cases, it is preferable that the operation control unit 135 estimates the output position of the output information by the virtual image or the real image from the movement direction and the angle of the arrival direction of the output information, and corrects the estimated arrival direction of the output information based on the output position. Moreover, when multiple output positions by the real image or the virtual image are estimated, in some cases, it is possible to estimate an output position with a large overlapping number as the output position by the real image. When the autonomous movement device 100 moves in the changed direction and the output position by the virtual image is estimated, in some cases, it is possible to set this position as the output position by the virtual image and determine the movement direction without consideration for the output position by the virtual image from the next determination.

### Characteristics and Effects of Embodiments

Characteristics and effects of the autonomous movement device 100 and the autonomous movement system 1000 according to the present embodiments are described below.

The autonomous movement device 100 according to a first aspect of the present disclosure that receives the output information outputted from the target object and that autonomously moves to the target object preferably includes an antenna unit configured to receive the output information and the angle estimation unit 134 configured to estimate the arrival direction of the output information. The antenna unit corresponds to the reception unit 110. Moreover, the autonomous movement device 100 preferably includes the reception strength determination unit 132 configured to determine the reception strength of the output information in the estimated arrival direction. Moreover, the autonomous movement device 100 preferably includes the operation control unit 135 configured to generate the movement direction information including the movement direction for moving the autonomous movement device, according to the estimated arrival direction and the magnitude of or change in the reception strength. Moreover, the autonomous movement device 100 preferably includes the drive unit 160 configured to generate the drive information corresponding to the movement direction information.

According to the aforementioned configuration, it is possible to autonomously reach an object being a target while employing a simple configuration to reduce cost in a movement device such as an unmanned transport device or the like.

The operation control unit 135 in the autonomous movement device 100 according to a second aspect of the present disclosure preferably sets the arrival direction of the output information with the highest reception strength, as the movement direction.

According to the aforementioned configuration, the autonomous movement device 100 always sets the direction in which the reception strength is high as the movement direction, and can thereby autonomously reach an object being a target while employing a simple configuration to reduce cost.

When a new arrival direction of the output information having a higher reception strength than the reception strength in the direction in which the autonomous movement device 100 is moving is estimated during the movement of the autonomous movement device 100, the operation control unit 135 according to a third aspect of the present disclosure preferably changes the movement direction of the autonomous movement device to the new arrival direction.

According to the aforementioned configuration, the autonomous movement device 100 always sets the direction in which the reception strength is high as the movement direction, and can thereby autonomously reach an object being a target while employing a simple configuration to reduce cost.

The operation control unit 135 in the autonomous movement device 100 according to a fourth aspect of the present disclosure preferably performs the following processing when a new arrival direction of the output information with a higher reception strength than the reception strength in a direction in which the autonomous movement device 100 is moving is estimated during the movement of the autonomous movement device 100. Specifically, the operation control unit 135 preferably changes the movement direction of the autonomous movement device 100 to an angle between the new arrival direction and the movement direction of the autonomous movement device 100.

According to the aforementioned configuration, also in the case where multiple reception strengths greatly fluctuate relative to one another, it is possible to smoothly change the movement direction without greatly changing the movement direction and achieve power saving.

The angle between the new arrival direction in the autonomous movement device 100 according to a fifth aspect of the present disclosure and the movement direction of the autonomous movement device 100 is preferably an angle obtained by weighting a difference in the reception strength to bring the angle closer to the new arrival direction or the movement direction of the autonomous movement device.

According to the aforementioned configuration, since the autonomous movement device 100 changes the movement direction based on the magnitude of the reception strength, it is possible to smoothly change the movement direction without greatly changing the movement direction and achieve power saving also in the case where there is variation in the reception strength.

The autonomous movement device 100 according to a sixth aspect of the present disclosure preferably performs the following processing when the autonomous movement device 100 is estimated to come into contact with an obstacle if the autonomous movement device 100 travels in the changed movement direction. Specifically, the operation control unit 135 preferably does not change the movement direction of the autonomous movement device up to a position where the contact with the obstacle is estimated to be avoided.

According to the aforementioned configuration, when there is a risk of the autonomous movement device 100 coming into contact with an obstacle if the autonomous movement device 100 immediately turns toward the new arrival direction, in some cases, the route can be selected such that the autonomous movement device 100 does not come into contact with the obstacle.

The operation control unit 135 in the autonomous movement device 100 according to a seventh aspect of the present disclosure preferably causes the autonomous movement device 100 to move a distance longer than a radius of the maximum arc formed by an outer shape of the autonomous movement device 100 in the case where the autonomous movement device 100 turns toward the new arrival direction. Then, the operation control unit 135 preferably changes the movement direction of the autonomous movement device 100 toward the new arrival direction.

According to the aforementioned configuration, the following operation is possible in some cases. Since the risk of the autonomous movement device 100 coming into contact with the obstacle in the width direction is high if the autonomous movement device 100 immediately turns toward the new arrival direction, the route is selected such that the outer shape of the autonomous movement device 100 does not come into contact.

When the reception strength of the output information determined by the reception strength determination unit 132 periodically oscillates, the operation control unit 135 according to an eighth aspect of the present disclosure preferably changes the movement direction of the autonomous movement device 100 from the movement direction in which the reception strength oscillates to a different movement direction.

According to the aforementioned configuration, even if the autonomous movement device 100 moves to the back side of an obstacle diffracting the output information, it is possible to detect this situation and autonomously avoid the obstacle in some cases.

The operation control unit 135 of the autonomous movement device 100 according to a ninth aspect of the present disclosure preferably sets a direction in which the reception strength is constant as the different movement direction.

According to the aforementioned configuration, even if the autonomous movement device 100 moves to the back side of the obstacle diffracting the output information, the autonomous movement device 100 can move in a direction of avoiding the obstacle in some cases.

The operation control unit 135 in the autonomous movement device 100 according to a tenth aspect of the present disclosure preferably travels a predetermined distance without changing the movement direction when the reception strength of the output information determined by the reception strength determination unit 132 falls below the predetermined threshold.

According to the aforementioned configuration, even if the output information is interfered due to reflection, diffraction or the like, it is possible to select a correct route regardless of an interference condition in some cases.

The operation control unit 135 according to an eleventh aspect of the present disclosure preferably generates the movement direction information with the arrival direction of the output information with the next highest reception strength being the new movement direction, when the movement direction is a direction in which the autonomous movement device 100 has moved in the past.

According to the aforementioned configuration, the autonomous movement device 100 can move based on the past movement history, and autonomously select a route that has a low reception strength but is correct, in some cases.

The operation control unit 135 in the autonomous movement device 100 according to a twelfth aspect of the present disclosure preferably executes the following processing when the movement direction indicated by the movement direction information is the direction in which the autonomous movement device 100 has moved in the past. Specifically, the operation control unit 135 preferably generates the movement direction information in which a direction that is different from the movement direction indicated by the movement direction information and that is not the direction in which the autonomous movement device 100 has moved in the past is the new movement direction.

According to the aforementioned configuration, the autonomous movement device 100 can move based on the past movement history. Accordingly, in some cases, it is possible to reduce the probability that the autonomous movement device 100 fails to move by taking the same route.

The new movement direction of the autonomous movement device 100 according to a thirteenth aspect of the present disclosure is preferably a direction in which the reception strength of the output information in the movement direction indicated by the movement direction information is estimated to decrease. Alternatively, the new movement direction is preferably a direction in which the reception strength of the output information in the movement direction indicated by the movement direction information is estimated to increase.

According to the aforementioned configuration, in a movement device such as an unmanned transport device, it is possible to determine the movement direction depending on a change in the reception strength of the output information when the movement device is receiving the output information from the direction of the past movement. Contact with an obstacle can be thereby avoided in some cases.

The operation control unit 135 according to a fourteenth aspect of the present disclosure preferably generates the movement direction information with a direction in which the autonomous movement device travels backward being the new movement direction, when a state where the reception strength of the output information in the movement direction indicated by the movement direction information does not change continues.

According to the aforementioned configuration, the autonomous movement device 100 can receive new output information in some cases by traveling backward when the autonomous movement device 100 collides with an obstacle and cannot travel forward.

The movement direction information of the autonomous movement device 100 according to a fifteenth aspect of the present disclosure is preferably associated with time for which the autonomous movement device 100 has moved in the movement direction, and the autonomous movement device 100 preferably further includes the movement direction information storage unit in which the movement direction information associated with the time for which the autonomous movement device 100 has moved in the movement direction is stored. The operation control unit 135 preferably creates the movement history information of the autonomous movement device from the past movement direction information, estimates presence of an obstacle from the movement history information, and changes the movement direction information for moving the autonomous movement device 100 such that the autonomous movement device 100 avoids the obstacle.

According to the aforementioned configuration, it is possible to autonomously reach an object being a target by using the movement history information created from the past movement direction information while employing a simple configuration to reduce cost in a movement device such as an unmanned transport device.

The autonomous movement device 100 according to a sixteenth aspect of the present disclosure preferably includes the information obtaining unit 150 configured to obtain information on an obstacle around the autonomous movement device. Moreover, the autonomous movement device 100 preferably includes the contact determination unit 136 configured to estimate and determine the contact between the autonomous movement device and the obstacle, from the movement direction information and the obtained information obtained by the information obtaining unit 150. The contact determination unit 136 preferably outputs the contact prediction information or the contact information between the autonomous movement device 100 and the obstacle to the operation control unit 135.

According to the aforementioned configuration, the autonomous movement device 100 can estimate and determine the contact between the autonomous movement device 100 and the obstacle from the movement direction information and the obtained information from the information obtaining unit 150.

The operation control unit 135 in the autonomous movement device 100 according to a seventeenth aspect of the present disclosure preferably changes the movement direction information to a direction of avoiding the obstacle, based on the contact prediction information or the contact information.

According to the aforementioned configuration, the autonomous movement device 100 can change the movement direction information when a contact with the obstacle is expected or when the autonomous movement device 100 is already in contact with the obstacle.

When the reception strength determination unit 132 in the autonomous movement device 100 according to an eighteenth aspect of the present disclosure determines that the output information has a reception strength exceeding the predetermined threshold, the autonomous movement device 100 preferably moves the predetermined distance. The angle estimation unit 134 preferably estimates the arrival direction of the output information during the movement. The operation control unit 135 preferably estimates the output position of the output information by the real image or the virtual image from the movement distance and the angle of the arrival direction of the output information, and corrects the estimated arrival direction of the output information based on the output position.

According to the aforementioned configuration, the autonomous movement device 100 can estimate the output position of the output information by the real image or the virtual image by autonomously moving, and reach the target object by performing movement by trial and error in which the radio wave arrival direction is corrected relative to the output position.

In the autonomous movement device 100 according to a nineteenth aspect of the present disclosure, when multiple output positions are estimated, the output position with the largest number of overlapping is preferably estimated as the output position by the real image, and the estimated arrival direction of the output information is corrected based on the output position by the real image.

According to the aforementioned configuration, the real image position of the target object can be estimated. Accordingly, the autonomous movement device 100 can autonomously reach an object being a target while correcting the arrival direction such that the autonomous movement device 100 moves toward the real image position, and at the same time have a simple configuration to reduce cost.

The autonomous movement system 1000 according to a twentieth aspect of the present disclosure preferably includes the autonomous movement device 100 according to one of the first to nineteenth aspects and the target object. The autonomous movement device 100 preferably includes the antenna unit including multiple reception elements configured to receive the output information periodically or non-periodically outputted. The antenna unit corresponds to the reception unit 110.

According to the aforementioned configuration, it is possible to autonomously reach an object being a target while employing a simple configuration to reduce cost in a movement device such as an unmanned transport device.

The output information in the autonomous movement system 1000 according to a twenty-first embodiment of the present disclosure is preferably at least one or both of an ultrasonic wave and an electromagnetic wave including a radio wave, a microwave, a visible light ray, and an infrared ray.

According to the aforementioned configuration, the autonomous movement device 100 can select the output information from various pieces of output information, depending on the environment of the autonomous movement device 100.

The frequency of the output information in the autonomous movement system 1000 according to a twenty-second aspect of the present disclosure preferably changes, and change pattern information of the frequency is preferably stored in the autonomous movement device 100.

According to the aforementioned configuration, changing the frequency enables reception of the output information also when the autonomous movement device 100 is located at a distant position in some cases. Moreover, changing the frequency enables reception of the output information also when the autonomous movement device 100 is hidden behind an obstacle in some cases.

The autonomous movement system 1000 according to a twenty-third aspect of the present disclosure further includes the movement unit 170 configured to be driven by the drive unit 160, and the movement unit 170 preferably has a configuration that enables movement on the ground, in the air, or in the water.

According to the aforementioned configuration, the autonomous movement device 100 can move on the ground, in the air, or in the water.

### Supplements of Embodiments

Although the embodiments of the present invention have been described above, the disclosed invention is not limited to these embodiments, and those skilled in the art will understand various modifications, corrections, alternatives, substitutes, and the like. Although description is given by using specific numerical examples to promote understanding of the invention, these numerical values are merely examples, and any suitable value may be used unless otherwise noted. Sectioning of the items in the aforementioned description is not essential to the present invention, and matters described in two or more items may be combined and used as necessary, or a matter described in a certain item may be applied to a matter described in another item (as long as there is no contradiction). Boundaries of the functional units and processors in the functional block diagrams do not necessarily correspond to boundaries of physical parts. Operations of multiple functional units may be physically performed in one part, or operations of one functional unit may be physically performed by multiple parts. Regarding the processing procedure described in the embodiments, the order of processing may be changed as long as there is no contradiction. Although the autonomous movement device 100 is described by using the functional block diagrams for convenience of describing the processing, the device may be implemented by hardware, software, or a combination of hardware and software. Software that is operated by a processor included in the autonomous movement device 100 according to the present embodiments may be saved in a random-access memory (RAM), a flash memory, a read-only memory (ROM), an EPROM, an EEPROM, or a register.

Moreover, the software that is operated by a processor included in the autonomous movement device 100 according to the present embodiments may be saved in a hard disk drive (HDD), a removal disc, a CD-ROM, a database, a server, or any other suitable recording medium.

Moreover, notification of information is not limited to the modes or embodiments described in the present disclosure. For example, other methods such as physical layer signaling, higher-layer signaling, other signals, or a combination of these may be used to perform the notification. Moreover, notification of predetermined information (for example, notification of “it is X) is not limited to explicitly-performed notification, and may be performed implicitly (for example, notification of the predetermined information is not performed).

Each of the aspects and embodiments described in the present disclosure may be applied by combining multiple systems.

The orders in the processing procedure, sequence, flowchart, and the like in each of the aspects and embodiments described in the present disclosure may be changed within a range without contradiction. For example, although elements of the various steps are presented by using the exemplarily orders in the description of the methods in the present disclosure, the present disclosure is not limited to the presented specific orders.

The inputted and outputted information and the like may be saved in a specific location such as, for example, a memory or managed by using a management table, and may be overwritten, updated, or added. The outputted information and the like may be deleted. The inputted information and the like may be transmitted to another device.

The determination in the present disclosure may be performed by comparison of numerical values such as, for example, comparison with a predetermined value, performed by using values expressed in one bit (0 or 1), or performed by using a truth value (Boolean: true or false).

Each of the aspects and embodiments described in the present disclosure may be used alone, or in combination with the other aspects and embodiments, and may be switched with execution.

The software should be widely interpreted to mean a code, a code segment, a program code, a program, a sub-program, a software module, an application, a software application, a software package, a routine, a sub-routine, an object, an executable file, an execution thread, a procedure, a function, and the like. Moreover, the software may be referred to by any name including firmware, middleware, micro code, hardware description language, or other names.

Moreover, the software, the information, and the like may be exchanged via a transmission medium. For example, when the software is transmitted from a website, a server, or other remote sources by using a wired technology, the wired technology is included in the definition of transmission medium. The wired technology includes a coaxial cable, an optical fiber cable, a twisted pair, a digital subscriber line, and the like. Moreover, when the software, the information, and the like are transmitted from a website, a server, or other remote sources by using a wireless technology such as an infrared ray, a microwave, and the like, the wireless technology is also included in the definition of transmission medium.

The information, signal, bit, and the like described in the present disclosure may be expressed by using any of various techniques such as, for example, voltage, a current, an electromagnetic wave, a magnetic field or a magnetic particle, an optical field or a photon, or any combination of these.

Note that the terms described in the present disclosure and the terms necessary for understanding of the present disclosure may be replaced by terms with the same or similar meanings.

Moreover, the information, parameters, and the like described in the present disclosure may each be expressed by using an absolute value or a relative value with respect to a predetermined value, or by using another piece of corresponding information.

The names used for the aforementioned parameters are in no respect limiting names. Since various information elements can be identified by using all suitable names, the various names assigned to these various information elements are in no respect limiting names.

The term “determining” used in the present disclosure includes various types of operations such as, for example, judging, calculating, computing, processing, and deriving in some cases. Moreover, “determining” may include, for example, investigating, searching, and inquiring a table or a database, and ascertaining. Furthermore, “determining” may include receiving (for example, receiving information), transmitting (for example, transmitting information), inputting, and outputting. Moreover, “determining” may include, for example, accessing data in the memory. Furthermore, “determining” may include resolving, selecting, choosing, establishing, comparing, and the like. Specifically, “determining” may include “determining” a certain operation. Moreover, “determining” may be replaced by “assuming”, “expecting”, “considering”, or the like.

The term “connected” or any modification of this term means any direct or indirect connection between two or more elements. The term “connected” may include a case where one or more intermediate elements is present between two elements “connected” to each other. When the term “connected” is used in the present disclosure, it can be assumed that the two elements are “connected” to each other by using at least one of one or more electric wires, cables, and printed electric connections. Moreover, as a non-limiting, non-comprehensive example, it can be assumed that the two elements are “connected” to each other by using electromagnetic energy or the like with a wavelength in a wireless frequency range, a microwave range, and a light (both of visible and invisible light) range.

The description “based on” used in the present disclosure does not mean “based only on” unless otherwise noted. Specifically, the description “based on” means both of “based only on” and “based at least on”.

The “unit” in the configurations of each device described above may be replaced by “means”, “circuit”, “device”, or the like.

The terms of “include” and “including” and terms obtained by modifying these terms that are used in the present disclosure are intended to be inclusive like the term “comprising”. Moreover, the term “or” used in the present disclosure is intended not to be exclusive OR.

In the present disclosure, for example, when articles such as a, an, and the in English are added by translation, the present disclosure may include the case where nouns subsequent to these articles are plural.

The term “A and B are different” in the present disclosure may also mean “A and B are different from each other”. Note that this term may also mean “A and B are each different from C”.

Although the details of the present disclosure have been described above, it is apparent to those skilled in the art that the present disclosure is not limited to the embodiments described in the present disclosure. The present disclosure can be carried out as corrected and modified modes without departing from the spirit and scope of the present disclosure defined by the description of the claims. Accordingly, the description of the present disclosure is provided for purpose of explanatory description, and does not have any meaning of limiting the present disclosure.

1. An autonomous movement device configured to receive output information outputted from a target object and autonomously move to the target object, the autonomous movement device comprising:
an antenna unit configured to receive the output information;
an angle estimation unit configured to estimate an arrival direction of the output information;
a reception strength determination unit configured to determine a reception strength of the output information in the estimated arrival direction;
an operation control unit configured generate movement direction information including a movement direction for moving the autonomous movement device, according to the estimated arrival direction and a magnitude of or a change in the reception strength; and
a drive unit configured to generate drive information corresponding to the movement direction information.

2. The autonomous movement device according to claim 1, wherein the operation control unit sets the arrival direction of the output information with the highest reception strength, as the movement direction.

3. The autonomous movement device according to claim 1, wherein, when a new arrival direction of the output information having a higher reception strength than the reception strength in a direction in which the autonomous movement device is moving is estimated during movement of the autonomous movement device, the operation control unit changes the movement direction of the autonomous movement device to the new arrival direction.

4. The autonomous movement device according to claim 1, wherein, when a new arrival direction of the output information with a higher reception strength than the reception strength in a direction in which the autonomous movement device is moving is estimated during movement of the autonomous movement device, the operation control unit changes the movement direction of the autonomous movement device to an angle between the new arrival direction and the movement direction of the autonomous movement device.

5. The autonomous movement device according to claim 4, wherein the angle between the new arrival direction and the movement direction of the autonomous movement device is an angle obtained by weighting a difference in the reception strength to bring the angle closer to the new arrival direction or the movement direction of the autonomous movement device.

6. The autonomous movement device according to claim 2, wherein, when the autonomous movement device is estimated to come into contact with an obstacle if the autonomous movement device travels in the changed movement direction, the operation control unit does not change the movement direction of the autonomous movement device up to a position where the contact with the obstacle is estimated to be avoided.

7. The autonomous movement device according to claim 3, wherein the operation control unit changes the movement direction of the autonomous movement device toward the new arrival direction after the autonomous movement device moves a distance longer than a radius of a maximum arc, formed by an outer shape of the autonomous movement device in a case where the autonomous movement device turns toward the new arrival direction, from a position of the autonomous movement device at the estimation of the new arrival direction.

8. The autonomous movement device according to claim 1, wherein, when the reception strength of the output information determined by the reception strength determination unit periodically oscillates, the operation control unit changes the movement direction of the autonomous movement device from the movement direction in which the reception strength oscillates to a different movement direction.

9. The autonomous movement device according to claim 8, wherein the operation control unit sets a direction in which the reception strength is constant as the different movement direction.

10. The autonomous movement device according to claim 1, wherein, when the output information determined by the reception strength determination unit falls below a predetermined threshold, the operation control unit travels a predetermined distance without changing the movement direction indicated by the movement direction information.

11. The autonomous movement device according to claim 1, wherein, when the movement direction indicated by the movement direction information is a direction in which the autonomous movement device has moved in the past, the operation control unit generates the movement direction information with the arrival direction of the output information with the next highest reception strength being the new movement direction.

12. The autonomous movement device according to claim 1, wherein, when the movement direction indicated by the movement direction information is a direction in which the autonomous movement device has moved in the past, the operation control unit generates the movement direction information in which a direction that is different from the movement direction and that is not the direction in which the autonomous movement device has moved in the past is the new movement direction.

13. The autonomous movement device according to claim 12, wherein the new movement direction is a direction in which the reception strength of the output information in the movement direction indicated by the movement direction information is estimated to decrease or a direction in which the reception strength of the output information in the movement direction indicated by the movement direction information is estimated to increase.

14. The autonomous movement device according to claim 1, wherein, when a state where the reception strength of the output information in the movement direction indicated by the movement direction information does not change continues, the operation control unit generates the movement direction information with a direction in which the autonomous movement device travels backward being the new movement direction.

15. The autonomous movement device according to claim 1, wherein
the movement direction information is associated with a time for which the autonomous movement device has moved in the movement direction,
the autonomous movement device further comprises a movement direction information storage unit in which the movement direction information associated with the time for which the autonomous movement device has moved in the movement direction is stored, and
the operation control unit creates movement history information of the autonomous movement device from the past movement direction information, estimates presence of an obstacle from the movement history information, and changes the movement direction information for moving the autonomous movement device such that the autonomous movement device avoids the obstacle.

16. The autonomous movement device according to claim 1, further comprising:
an information obtaining unit configured to obtain information on an obstacle around the autonomous movement device; and
a contact determination unit configured to estimate and determine contact between the autonomous movement device and the obstacle, from the movement direction information and obtained information obtained by the information obtaining unit, wherein
the contact determination unit outputs contact prediction information or contact information between the autonomous movement device and the obstacle to the operation control unit.

17. The autonomous movement device according to claim 16, wherein the operation control unit changes the movement direction information to a direction of avoiding the obstacle, based on the contact prediction information or the contact information.

18. The autonomous movement device according to claim 1, wherein, when the reception strength determination unit determines that the output information has a reception strength exceeding a predetermined threshold, the autonomous movement device moves a predetermined distance, the angle estimation unit estimates the arrival direction of the output information during the movement, and the operation control unit estimates an output position of the output information by a real image or a virtual image from a movement distance and an angle of the arrival direction of the output information, and corrects the estimated arrival direction of the output information based on the output position.

19. The autonomous movement device according to claim 18, wherein, when a plurality of the output positions are estimated, the output position with the largest number of overlapping is estimated as the output position by the real image, and the estimated arrival direction of the output information is corrected based on the output position by the real image.

20. An autonomous movement system comprising:
the autonomous movement device according to claim 1; and
the target object, wherein
the output information is periodically or non-periodically outputted, and
the autonomous movement device includes the antenna unit including a plurality of reception elements configured to receive the output information.

21. The autonomous movement system according to claim 20, wherein the output information is at least one or both of an ultrasonic wave and an electromagnetic wave including a radio wave, a microwave, a visible light ray, and an infrared ray.

22. The autonomous movement system according to claim 21, wherein a frequency of the output information changes, and change pattern information of the frequency is stored in the autonomous movement device.

23. The autonomous movement system according to claim 20, further comprising a movement unit configured to be driven by the drive unit, wherein
the movement unit has a configuration that enables movement on the ground, in the air, or in the water.
